(19) United States
(12) Patent Application Publication
(10) Pub. No.: US 2017/0368583 A1
(43) Pub. Date: Dec. 28, 2017

(54) FOREIGN BODY REMOVING METHOD AND FOREIGN BODY REMOVING DEVICE

(71) Applicant: Sapporo Holdings Limited, Shibuya-ku, Tokyo (JP)

(72) Inventors: Masashi HOSAKA, Shibuya-ku (JP); Yukihiro KUBOYAMA, Shibuya-ku (JP); Tsuyoshi ARIGAYA, Shibuya-ku (JP); Yoshihiko AWAYA, Shibuya-ku (JP)

(73) Assignee: Sapporo Holdings Limited, Shibuya-ku, Tokyo (JP)

(21) Appl. No.: 15/542,753

(22) PCT Filed: Sep. 2, 2016
(86) PCT No.: PCT/JP2016/075819

§ 371 Date: Jul. 11, 2017

(30) Foreign Application Priority Data
Sep. 8, 2015 (JP) 2015-176841

(51) Int. Cl. B08B 9/28; B08B 9/30

(52) U.S. Cl. CPC B08B 9/286; B08B 9/30

(57) ABSTRACT

A foreign object removal apparatus removes a foreign object attached on a can body by rinsing the can body. The foreign object removal apparatus includes a conveyance line configured to convey the can body, a destaticizing air blower configured to blow a destaticizing air to the conveyed can body, and a rinser configured to rinse the can body after blowing the destaticizing air using the destaticizing air blower.

### TECHNICAL FIELD

The present invention relates to a foreign object removal method and a foreign object removal apparatus for removing a foreign object attached on a can body.

### BACKGROUND ART

A canning material where beer, alcoholic beverages, or refreshing beverages are filled consists of a can body and a can lid. The can body is rinsed using a washing machine, called a rinser, before filling the beverages or the like. The can body which passes through a conveyance line is conveyed to the rinser, and a rinse process is performed, in which an inner surface of the can body is rinsed using water or air by the rinser. The rinse process includes a process of reversing the can body such that an opening of the can body faces down, a process of rinsing the can body by blowing water or air to the reversed can body, and a process of rotating the can body to its normal position such that the opening of the rinsed can body faces up.

Japanese Unexamined Patent Publication No. 2012-86113 discloses a rinser provided with a conveyance apparatus that conveys a can body, a plurality of two-fluid nozzle placed with a predetermined pitch along a conveyance direction of the can body, a single one-fluid nozzle placed in the downstream side of the two-fluid nozzle in the conveyance path of the can body. The two-fluid nozzle sprays a gas-water mixture mist obtained by mixing a pressurized gas and rinse water into the inner surface of the conveyed can body. This gas-water mixture mist is formed of mist-like water particles, and the two-fluid nozzle sprays the gas-water mixture mist in a conical or fan-like shape. The one-fluid nozzle sprays only the rinse water into the inner surface of the can. The one-fluid nozzle blows an amount of the rinse water into the inner surface of the can body to rinse the inner surface of the can body.

### CITATION LIST

### Patent Literature

Patent Literature 1: Japanese Unexamined Patent Publication No. 2012-86113

### SUMMARY OF INVENTION

### Technical Problem

If any foreign object is attached on the can body, it is necessary to reliably remove the foreign object with the aforementioned rinse process. However, friction may occur between the attached foreign object and the metal surface of the can body until the can body passes through the conveyance line and is conveyed to the rinser. This friction may generate static electricity in the foreign object. In this manner, the foreign object having the static electricity is attached on the metal surface of the can body due to static electricity. Therefore, some foreign object is not removed even by blowing water and air in the process of rinsing the can body. Accordingly, it is desirable to more reliably remove the foreign object in the process of rinsing the can body.

In this regard, according to an aspect of the present invention, an object is to provide a foreign object removal method and a foreign object removal apparatus capable of more reliably removing a foreign object in the process of rinsing the can body.

### Solution to Problem

According to an aspect of the present invention, there is provided a foreign object removal method for removing a foreign object attached on a can body by rinsing the can body, including processes of: conveying the can body; blowing a destaticizing air to the conveyed can body; and rinsing the can body after blowing the destaticizing air in the process of blowing the destaticizing air.

In the foreign object removal method according to an aspect of the present invention, the destaticizing air is blown to the conveyed can body before the rinsing. In this manner, the can body and the foreign object are destaticized by blowing the destaticizing air to the conveyed can body. Therefore, it is possible to remove static electricity from a foreign object attached on the can body. Accordingly, since a foreign object attached on a metal surface of the can body due to static electricity can be removed, it is possible to more reliably remove the foreign object in the subsequent process of rinsing the can body.

The foreign object removal method may further include a process of reversing the can body such that the can body faces down before the process of rinsing the can body, in which the process of blowing the destaticizing air is performed before the process of reversing the can body. In this case, since the process of reversing the can body is performed after the process of blowing the destaticizing air, it is possible to place a device for blowing the destaticizing air in the upstream side of the rinser in the conveyance path of the can body. Therefore, it is possible to remove a foreign object attached on the metal surface of the can body before the can body is conveyed to the rinser.

The foreign object removal method may further include a process of reversing the can body such that the can body faces down before the process of rinsing the can body, in which the process of blowing the destaticizing air is performed after the process of reversing the can body. As a result, since the destaticizing air can be blown to the can body immediately before the process of rinsing the can body, it is possible to rinse the can body while a destaticization state of the can body is reliably maintained. Therefore, it is possible to more reliably remove the foreign object, whose static electricity has been eliminated, in the rinse process.

The process of blowing the destaticizing air may be performed by blowing the destaticizing air to an opening of the can body downward. In this case, the device for blowing the destaticizing air may be provided above the conveyed can body. As a result, it is possible to easily install the device for blowing the destaticizing air, compared to a case where the device for blowing the destaticizing air is provided beside or below the conveyed can body.

According to an aspect of the present invention, there is provided a foreign object removal apparatus for removing a foreign object attached on a can body by rinsing the can body, including: a conveyance portion configured to convey the can body; a destaticizing air blowing portion configured to blow a destaticizing air to the conveyed can body; and a rinsing portion configured to rinse the can body after blowing the destaticizing air using the destaticizing air blowing portion.

In the foreign object removal apparatus according to an aspect of the present invention, the destaticizing air is blown to the can body conveyed by the conveyance portion before the rinsing. Therefore, since electrification of the can body is eliminated by the destaticizing air before the rinsing, it is possible to remove static electricity of the foreign object before the rinsing. Accordingly, it is possible to remove the foreign object attached on the metal surface of the can body due to static electricity. As a result, it is possible to more reliably remove the foreign object in the subsequent process of rinsing the can body.

### Advantageous Effects of Invention

According to an aspect of the present invention, it is possible to more reliably remove a foreign object in a process of rinsing a can body.

### BRIEF DESCRIPTION OF DRAWINGS

FIG. 1 is schematic configuration diagram illustrating a foreign object removal apparatus according to a first embodiment.

FIG. 2 is a cross-sectional view illustrating a state in which a destaticizing air is blown to an inner surface of a can body.

FIG. 3 is a flowchart illustrating each process performed by the foreign object removal apparatus of FIG. 1.

FIG. 4 is a schematic configuration diagram illustrating a foreign object removal apparatus according to a second embodiment.

FIG. 5 is a flowchart illustrating each process performed by the foreign object removal apparatus of FIG. 4.

FIG. 6 is a schematic configuration diagram illustrating a foreign object removal apparatus according to a modification.

### DESCRIPTION OF EMBODIMENTS

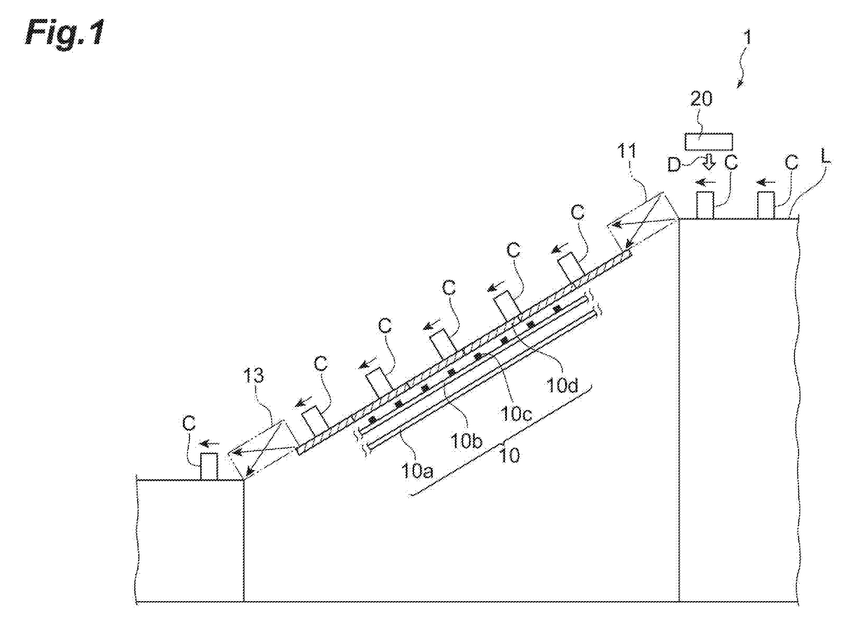

A foreign object removal method and a foreign object removal apparatus of a can body will be described in details with reference to the accompanying drawings. The elements same with or similar to each other in the description of the drawings are given the same reference signs, and duplicate description thereof will be omitted. Note that, in FIGS. 1, 4, and 6, some detailed structures of an apparatus are not illustrated for making drawings easily understandable.

### First Embodiment

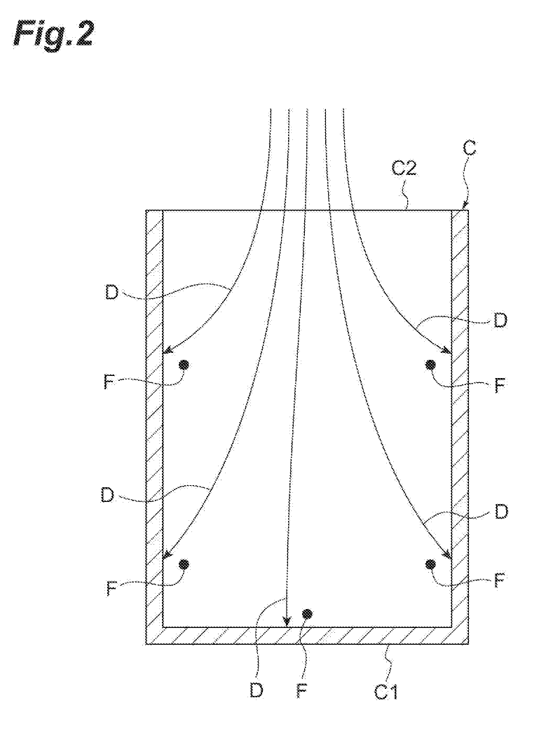

As illustrated in FIGS. 1 and 2, a foreign object removal apparatus 1 according to a first embodiment is equipped, for example, in a canning factory where content such as a beverage is filled in a can body C, a can lid is covered on the can body C, and seaming is performed. For example, the can body C is a bottomed-cylindrical metal can having a bottom portion C1 and an opening C2 located oppositely to the bottom portion C1.

The foreign object removal apparatus 1 is provided with a rinser (rinsing portion) 10 for rinsing the can body C. The can body C is conveyed on a conveyance line (conveyance portion) L and arrives at the rinser 10, by which the can body C is rinsed. Then, the content is filled in the can body C. The rinser 10 extends obliquely downward from the conveyance line L and rinses the can body C on a conveyance path extending obliquely downward. Note that, a filler for filling the content in the can body C is provided in the end of the conveyance path of the rinser 10 of the can body C extending obliquely downward.

The foreign object removal apparatus 1 has a reversing portion 11 that reverses the can body C conveyed from the conveyance line L and a normal positioning portion 13 that rotates the can body C rinsed by the rinser 10 in a normal position. With respect to the obliquely extending rinser 10, the reversing portion 11 is placed in the upstream of the rinser 10, and the normal positioning portion 13 is placed in the downstream of the rinser 10. Here, the “normal position” refers to a state in which the opening C2 of the can body C faces up, and the “reversed position” refers to a state in which the opening C2 of the can body C faces down.

The opening C2 of the can body C faces up until the can body C arrives at the reversing portion 11 from the conveyance line L. After the can body C arrives at the reversing portion 11, it is reversed such that the opening C2 faces down. The reversing portion 11 includes, for example, a plurality of twisted round bar members, and the can body C is reversed as it passes between the plurality of twisted round bar members. Such round bar members serve as a guide member for reversing the can body C while supporting the can body C.

The rinser 10 rinses the can body C reversed by the reversing portion 11. The rinser 10 includes, for example, an air supply pipe 10a, a rinse water supply pipe 10b, a rinsing nozzle 10c, and a guide rail 10d. The air supply pipe 10a and the rinse water supply pipe 10b extend obliquely along the guide rail 10d, and a plurality of rinsing nozzles 10c are placed along the guide rail 10d.

Each of the rinsing nozzles 10c blows the air passing through the air supply pipe 10a, the rinse water passing through the rinse water supply pipe 10b, or both the air and the rinse water into the inner surface of the can body C to rinse the can body C. Note that the rinsing method for the can body C using the rinser 10 may be appropriately changed. For example, a foreign object on the can body C may be blown only using the air passing through the air supply pipe 10a, or the rinsing may be performed by spraying the gas-liquid mixture formed by mixing the pressurized air and the rinse water into the can body C. In addition, the configuration of the rinser 10 may also be appropriately changed.

The normal positioning portion 13 rotates the can body C subjected to the rinsing of the rinser 10 into a normal position. Similar to the reversing portion 11, the normal positioning portion 13 includes, for example, a plurality of twisted round bar members. The can body C is rotated to the normal position as the can body C passes between the plurality of round bar members. The can body C rotated by the normal positioning portion 13 is conveyed to the filler positioned in the downstream side of the normal positioning portion 13 in the conveyance path of the can body C.

As described above, the foreign object removal apparatus 1 removes a foreign object F attached on the can body C by rinsing the can body C using the rinser 10. Here, the foreign object F may include, for example, a chip board piece of a pallet used to convey the can body C, a film piece wound around the can body C during delivery, hair, and the like. The foreign object removal apparatus 1 includes the conveyance line L described above, the rinser 10, and a destaticizing air blower (destaticizing air blowing portion) 20 that blows the destaticizing air D to the can body C. The destaticizing air blower 20 is placed between the conveyance line L and the rinser 10 in the conveyance path of the can body C, that is, in the upstream side of the rinser 10 in the conveyance path of the can body C.

A position where the destaticizing air D is blown by the destaticizing air blower 20 in the conveyance path of the can body C adjoins, for example, a position of the reversing portion 11. In addition, the destaticizing air blower 20 is placed above the can body C to blow the destaticizing air D to the opening C2 of the can body C downward. The destaticizing air D is blown to the inner surface of the can body C. However, the destaticizing air D may also be blown to the outer surface of the can body C, or may be blown to both the inner and outer surfaces of the can body C.

The destaticizing air D blowing from the destaticizing air blower 20 contains destaticizing ions and the air for carrying the destaticizing ions. The air may include various gases such as the atmospheric air or a nitrogen gas. The destaticizing air D is blown to the inner surface of the can body C as the destaticizing ions are carried by the air. In addition, various devices may be employed as the destaticizing air blower 20, and the shape and size of the destaticizing air blower 20 may be appropriately changed.

As described above, the destaticizing air blower 20 blows the destaticizing air D to the can body C before the can body C is conveyed to the rinser 10. Specifically, the destaticizing air blower 20 blows the destaticizing air D to the can body C before the can body C is reversed by the reversing portion 11. By blowing the destaticizing air D to the can body C, the destaticizing ions and the air are supplied to a foreign object F attached on the inner surface of the can body C, so that the foreign object F is removed from the inner surface.

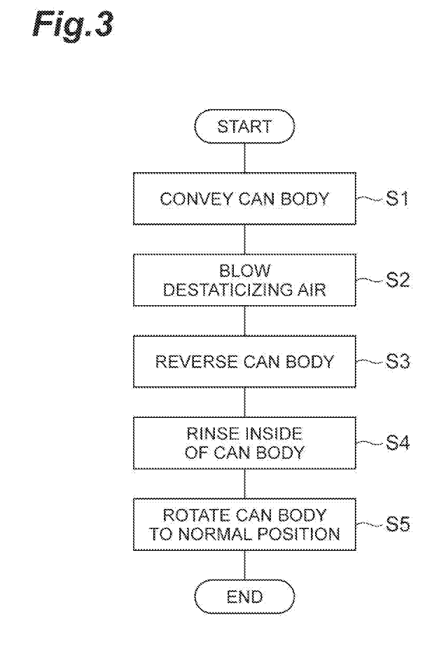

A foreign object removal method for removing a foreign object F from the can body C using the foreign object removal apparatus 1 will be described with reference to the flowchart of FIG. 3. FIG. 3 illustrates an exemplary foreign object removal method using the foreign object removal apparatus 1.

First, a process of conveying the can body C is executed to convey the can body C on the conveyance line L (step S1). Then, a process of blowing the destaticizing air D to the can body C is executed (step S2). In step S2, the destaticizing air D is blown, for example, downward to the inner surface of the can body C, so that the destaticizing ions collide with the foreign object F. As a result, electrification between the foreign object F and the inner surface of the can body C is eliminated.

In addition, the can body C arrives at the reversing portion 11, and a process of reversing the can body C is executed. In this case, the reversing portion 11 reverses the can body C subjected to the process of blowing the destaticizing air D (step S3). Subsequently, a process of rinsing the can body C is executed, so that the rinser 10 blows the air or the rinse water to the can body C reversed by the reversing portion 11 to rinse the inside of the can body C (step S4). Then, the process advances to step S5, so that the can body C rinsed by the rinsing portion 12 is rotated by the normal positioning portion 13 to the normal position. As a result, a series of processes are completed. Note that the content is filled in the can body C rotated by the normal positioning portion 13 to the normal position using the filler positioned in the downstream side of the normal positioning portion 13.

Next, functional effects of the foreign object removal method and the foreign object removal apparatus 1 according to this embodiment will be described. First, in the foreign object removal method and the foreign object removal apparatus 1 according to this embodiment, the destaticizing air D is blown to the conveyed can body C before the rinsing. In this manner, since the electrification of the can body C is eliminated by blowing the destaticizing air D to the conveyed can body C, it is possible to remove static electricity of a foreign object F attached on the can body C. Therefore, since it is possible to remove a foreign object F attached on the inner surface of the can body C by static electricity, it is possible to more reliably remove a foreign object F in the subsequent process of rinsing the can body C. That is, after destaticization, a foreign object F is reliably removed from the can body C through a normal rinse process.

According to this embodiment, a process of reversing the can body C is executed such that the can body C faces down before the process of rinsing the can body C, and the process of blowing the destaticizing air D is performed before the process of reversing the can body C. Therefore, since the process of reversing the can body C is executed after the process of blowing the destaticizing air D, it is possible to place the destaticizing air blower 20 in the upstream side of the rinser 10 in the conveyance path of the can body C. Therefore, it is possible to remove a foreign object F attached on the inner surface of the can body C before the can body C is conveyed to the rinser 10. Furthermore, since the destaticizing air blower 20 is placed in the upstream side of the rinser 10, any modification of the rinser 10 is not necessary when the destaticizing air blower 20 is placed.

The process of blowing the destaticizing air D is performed by blowing the destaticizing air D to the opening C2 of the can body C downward. Therefore, it is possible to place the destaticizing air blower 20 above the conveyed can body C. As a result, it is only necessary to install the destaticizing air blower 20 above the existing facility. Therefore, it is possible to easily install the destaticizing air blower 20, compared to a case where the destaticizing air blower 20 is installed beside or below the conveyed can body C.

Furthermore, in the conveyance path of the can body C, a position where the destaticizing air D is blown by the destaticizing air blower 20 is contiguous to the position of the reversing portion 11. Therefore, the can body C is reversed by the reversing portion 11 immediately after destaticization is performed by blowing the destaticizing air D. Then, the can body C is rinsed by the rinser 10. Therefore, the can body C is rinsed while the destaticization state is reliably maintained using the destaticizing air D. Accordingly, it is possible to more reliably remove a foreign object F through the rinsing.

### Second Embodiment

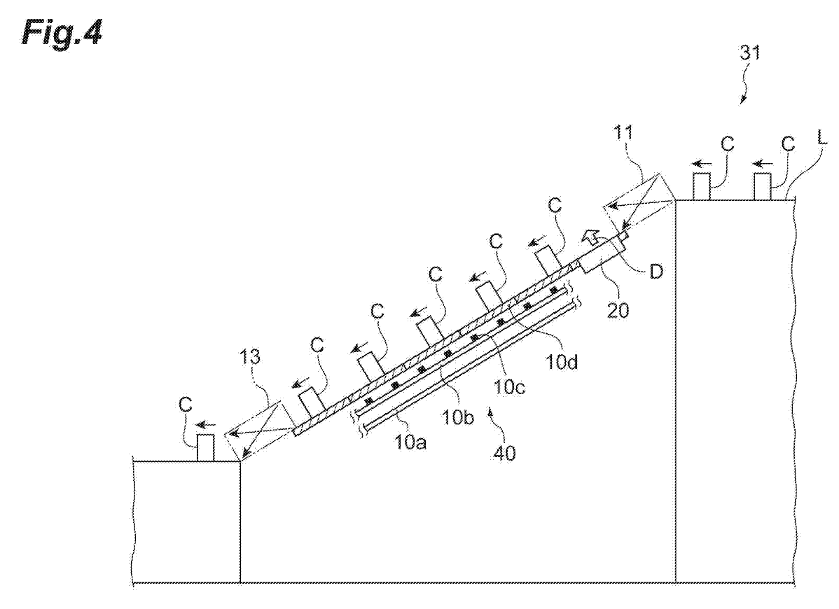

A foreign object removal method and a foreign object removal apparatus 31 according to a second embodiment will now be described with reference to FIG. 4. In explanations of the second embodiment, explanations for elements duplicating the first embodiment will be omitted. As illustrated in FIG. 4, in the foreign object removal apparatus 31 according to the second embodiment, a position of the destaticizing air blower 20 is different from that of the foreign object removal apparatus 1 of the first embodiment. The foreign object removal apparatus 31 has the conveyance line L and the rinser 40 as described above, and the destaticizing air blower 20 is provided in the inside of the rinser 40.

The foreign object removal apparatus 31 has the reversing portion 11 and the normal positioning portion 13 similar to those of the first embodiment, and the destaticizing air blower 20 of the second embodiment is placed in the downstream side of the reversing portion 11 in the conveyance path of the can body C. The destaticizing air blower 20 blows the destaticizing air D upward to the opening C2 of the can body C reversed by the reversing portion 11 to perform destaticization.

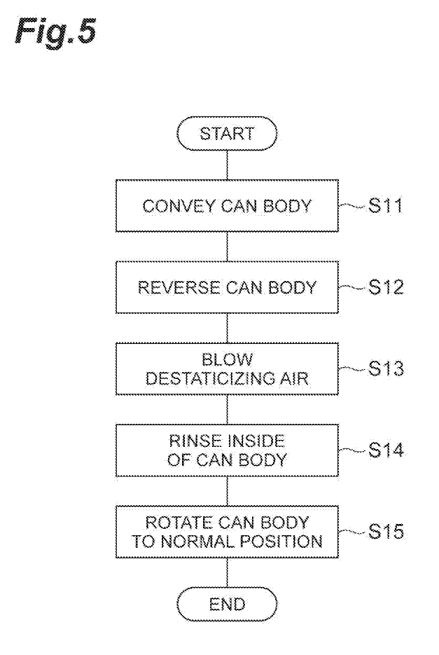

Next, a foreign object removal method for removing a foreign object F from the can body C using the foreign object removal apparatus 31 will be described with reference to the flowchart of FIG. 5. First, similar to step S1, a process of conveying the can body C is executed (step S11). In addition, the can body C arrives at the reversing portion 11, and a process of reversing the can body C is executed as in step S3 (step S12). Then, the process advances to step S13, where a process of blowing the destaticizing air D to the opening C2 of the can body C is executed, so that the destaticizing air D is blown to the inner surface of the can body C upward (step S13). In this manner, after blowing the destaticizing air D to the can body C, the process advances to steps S14 and S15, where similar to steps S4 and S5, a process of rinsing the can body C and a process of rotating the can body C to its normal position are executed, so that a series of processes are completed.

In the foreign object removal method and the foreign object removal apparatus 31 according to the second embodiment described above, the destaticizing air D is blown to the conveyed can body C, and the can body C is then rinsed by the rinser 40. Therefore, a foreign object F is reliably removed from the can body C through a normal rinse process after destaticization. Accordingly, it is possible to obtain effects similar to those of the first embodiment.

According to the second embodiment, before the process of rinsing the can body C, the process of reversing the can body C such that the can body C faces down is performed. In addition, the process of blowing the destaticizing air D is performed after the process of reversing the can body C. Therefore, since the destaticizing air D can be blown to the can body C immediately before the process of rinsing the can body C, it is possible to rinse the can body C while the destaticization state of the can body C is reliably maintained. Therefore, it is possible to more reliably remove the foreign object F, whose static electricity has been eliminated, in the rinse process.

Furthermore, a position where the destaticizing air D is blown by the destaticizing air blower 20 in the conveyance path of the can body C is located between the reversing portion 11 and the rinser 40. Therefore, the can body C is rinsed by the rinser 40 immediately after destaticization is performed by blowing the destaticizing air D. Therefore, the can body C is rinsed while the destaticization state using the destaticizing air D is reliably maintained. Accordingly, it is possible to more reliably remove a foreign object F through the rinsing. In addition, even when the destaticizing air blower 20 is provided in the downstream side of the reversing portion 11, it is possible to remove necessity of modifying the rinser 40 due to the installation place of the destaticizing air blower 20.

While the embodiments of the present invention have been described hereinbefore, they are not intended to limit the present invention, and may be modified or applied to other fields without changing the subject matter described in each claim. That is, various modifications or changes may be possible without departing from the spirit and scope of the invention as described in the attached claims. In addition, configurations and shapes of each part of the foreign object removal apparatus may also be appropriately changed without departing from the spirit and scope of the present invention.

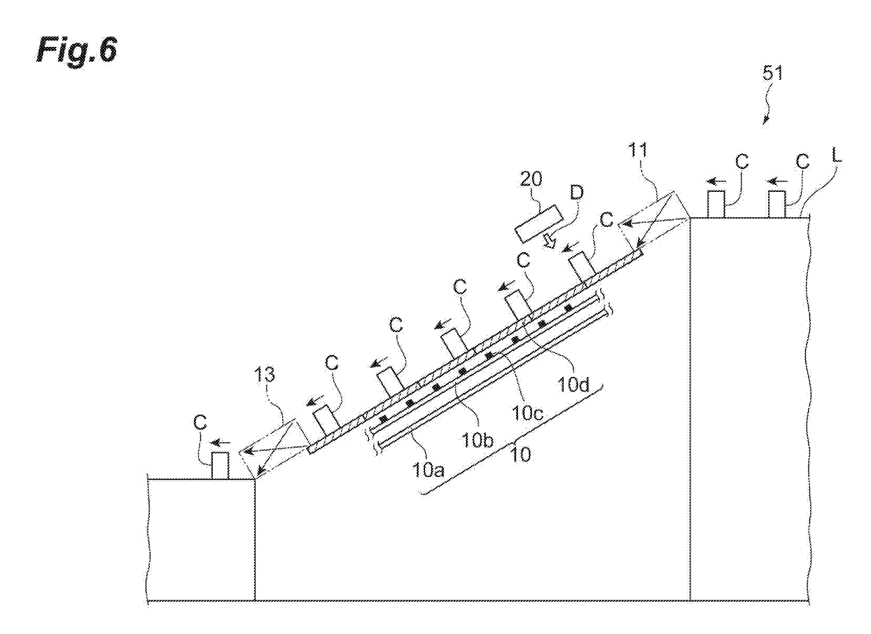

For example, the foreign object removal apparatus according to the aforementioned embodiment has the destaticizing air blower 20 for blowing the destaticizing air D to the can body C. However, for example, as in the foreign object removal apparatus 51 illustrated in FIG. 6, the destaticizing air blower 20 may be provided to blow the destaticizing air D to the inside of the rinser 10. In this destaticizing air blower 20, for example, the destaticizing air D may be blown to the conveyance path of the can body C inside the rinser 10, or the destaticizing air D may be blown to each device of the rinser 10.

In this manner, in the foreign object removal apparatus 51 provided with the destaticizing air blower 20 that blows the destaticizing air D to the inside of the rinser 10, it is possible to avoid a foreign object F from being accumulated in the rinser 10. Here, in the absence of the destaticizing air blower 20, it is necessary to periodically disassemble the rinser and manually clean the rinser for a long time. In contrast, in the case of the foreign object removal apparatus 51 provided with the destaticizing air blower 20 described above, it is possible to avoid a foreign object F from being accumulated in the rinser 10. Therefore, it is possible to omit the cleaning and avoid microorganisms from being easily generated due to accumulation of the foreign object F. Accordingly, using the foreign object removal apparatus 51, it is possible to avoid the environment inside the rinser 10 from being worsen.

According to the first embodiment described above, the destaticizing air blower 20 is provided above the conveyed can body C, and the destaticizing air D is blown to the can body C downward. However, in the second embodiment described above, the destaticizing air D may be blown to the can body C downward. In addition, a direction of blowing the destaticizing air D may also be appropriately changed. For example, the destaticizing air D may be blown obliquely.

Next, an experiment performed using the foreign object removal apparatus according to the aforementioned embodiment will be described. In this experiment, the hair, a paper chip board piece as a pallet for conveying the can body C, and a polyethylene shrink film as a film piece wound around the can body C was used as a foreign object F. These hair, chip board piece, and shrink film are foreign objects F that may actually enter the can body C. Therefore, the experiment was performed by attaching these three types of foreign objects F onto the can body C, conveying the can body C to the foreign object removal apparatus, and examining whether or not the foreign object F can be removed.

First, the hair is easily charged positively, and the shrink film is easily charged negatively. The chip board piece is not easily charged. Therefore, out of the foreign objects F used in this experiment, the hair and the shrink film were electrically charged and were attached on the can body C.

The aforementioned experiment was performed using a foreign object removal apparatus having no destaticizing air blower and no rinser. As a result, it was difficult to remove the chip board piece, the shrink film, and the hair from the can body C just by reversing the can body C using the reversing portion. In addition, the aforementioned experiment was performed using a foreign object removal apparatus having the rinser but no destaticizing air blower. As a result, the chip board piece and the hair could be removed, but it was difficult to remove the shrink film. From the aforementioned description, it was recognized that a non-electrified foreign object can be removed even using the foreign object removal apparatus having the rinser but no destaticizing air blower. In addition, it is estimated that the hair can be removed even when it is electrified because its contact area with the can body C is small.

The aforementioned experiment was performed using a foreign object removal apparatus having both the destaticizing air blower and the rinser. As a result, it was possible to remove all of the chip board piece, the hair, and the shrink film. In this manner, it was recognized that the three types of foreign objects F can be reliably removed using the foreign object removal apparatus having both the rinser and the destaticizing air blower. In particular, it was recognized that the shrink film can be more reliably removed if a distance between the destaticizing air blower and the rinser is short.

### REFERENCE SIGNS LIST

1, 31, 51 . . . foreign object removal apparatus, 10, 40 . . . rinser (rinsing portion), 10a . . . air supply pipe, 10b . . . rinse water supply pipe, 10c . . . rinsing nozzle, 11 . . . reversing portion, 13 . . . normal positioning portion, 20 . . . destaticizing air blower (destaticizing air blowing portion), C . . . can body, C1 . . . bottom portion, C2 . . . opening, D . . . destaticizing air, F . . . foreign object, L . . . conveyance line (conveyance portion).

1. A method for removing a foreign object attached on a can body, the method comprising:
blowing a destaticizing air to a conveyed can body; and
rinsing the can body after blowing the destaticizing air in the process of blowing the destaticizing air.

2. The foreign object removal method according to claim 1, further comprising:
reversing the can body such that the can body faces down before the rinsing,
wherein the blowing is performed before the reversing.

3. The method according to claim 1, further comprising:
reversing the can body such that the can body faces down before the rinsing,
wherein the blowing is performed after the reversing.

4. The method according to claim 1,
wherein the blowing is performed by blowing the destaticizing air to an opening of the can body downward.

5. An apparatus for removing a foreign object attached on a can body by rinsing the can body, the apparatus comprising:
a conveyance portion configured to convey the can body;
a destaticizing air blowing portion configured to blow a destaticizing air to the conveyed can body; and
a rinsing portion configured to rinse the can body after blowing the destaticizing air.
